(19) United States
(12) Patent Application Publication
(10) Pub. No.: US 2023/0401665 A1
(43) Pub. Date: Dec. 14, 2023

(54) ARTIFICIAL INTELLIGENCE FUNCTIONALITY DEPLOYMENT SYSTEM AND METHOD AND SYSTEM AND METHOD USING SAME

(71) Applicant: PLEORA TECHNOLOGIES INC., Kanata (CA)

(72) Inventors: Chris Eric Warkentin, Ottawa (CA); Jonathan Chapman Hou, Stittsville (CA); Glenn Andrew Varsava, Stittsville (CA); Zachary Jeremy O'Beirn, Braeside (CA); Yuying Zhang, Kanata (CA)

(21) Appl. No.: 18/035,433

(22) PCT Filed: Nov. 9, 2021
(86) PCT No.: PCT/CA2021/051593

§ 371 Date: May 4, 2023

(30) Foreign Application Priority Data
Nov. 9, 2020 (CA) 3098755

(51) Int. Cl. G06T 1/00; G06T 5/00; G06T 5/50

(52) U.S. Cl. CPC G06T 1/0014; G06T 5/006; G06T 5/50

(57) ABSTRACT

A machine vision functionality deployment system for transcoding a raw machine vision data signal in an existing machine vision system for capturing sensed information from a substrate. Provided is a digital data interface bus to: receive raw machine vision digital data signals from an acquisition device. The raw machine vision digital data signals are in an acquisition device format and to output a transcoded machine vision digital data signal to a consumption device in a consumption device format. A digital data processor in communication to the digital data interface bus operable to: identify digital data elements associated with an artifact of the substrate in the raw machine vision digital data signal, wherein the artifact is not detectable by the consumption device; transcode the raw machine vision digital data signal by rendering the artifact detectable in the transcoded machine vision digital data signal by the consumption device.

### RELATED APPLICATION

The instant application is related to and claims benefit of priority to Canadian Patent Application serial number: 3,098,755, filed Nov. 9, 2020 and entitled “ARTIFICIAL INTELLIGENCE FUNCTIONALITY DEPLOYMENT SYSTEM AND METHOD AND SYSTEM AND METHOD USING SAME”, the disclosure of which is herein fully incorporated by reference.

### FIELD OF THE DISCLOSURE

The present disclosure relates to machine vision inspection, in particular, to artificial intelligence functionality deployment system and method and method and system using same.

### BACKGROUND

Deployment of artificial intelligence (AI) for vision inspection applications, for example in industrial and/or manufacturing settings, may be costly and time consuming due to a few key factors. Primarily, new capabilities must fit seamlessly within existing systems where there has been a significant investment in cameras and processing systems. Related to this, there are proven end-user processes that need to be maintained while adding new capabilities. Finally, there is concern that algorithm training is a long, complex, and costly process that requires outside expertise for many companies.

This background information is provided to reveal information believed by the applicant to be of possible relevance. No admission is necessarily intended, nor should be construed, that any of the preceding information constitutes prior art or forms part of the general common knowledge in the relevant art.

### SUMMARY

The following presents a simplified summary of the general inventive concept(s) described herein to provide a basic understanding of some aspects of the disclosure. This summary is not an extensive overview of the disclosure. It is not intended to restrict key or critical elements of embodiments of the disclosure or to delineate their scope beyond that which is explicitly or implicitly described by the following description and claims.

In accordance with one aspect, there is provided A machine vision functionality deployment system for transcoding a raw machine vision data signal in an existing machine vision system capturing sensed information from a substrate, the system comprising: a digital data interface bus that is operable to: receive said raw machine vision digital data signal from an acquisition device, wherein said raw machine vision digital data signal is in an acquisition device format; output a transcoded machine vision digital data signal to a consumption device, wherein said transcoded machine vision digital data signal is in a consumption device format; a digital data processor communicatively linked to said digital data interface bus, and said digital data processor operable to: identify digital data elements associated with an artifact of said substrate in said raw machine vision digital data signal, wherein said artifact is not detectable by said consumption device; transcode the raw machine vision digital data signal by rendering the artifact detectable in the transcoded machine vision digital data signal by said consumption device.

In some embodiments, the acquisition device format and the consumption device format are compatible or are the same format.

In some embodiments, the at least one of said acquisition device format and the consumption device format comprises an ethernet-based communication protocol.

In some embodiments, the ethernet-based communication protocol may be chosen from the following: GigE Vision, USB3 Vision, Camera Link, MIPI or GenICam.

In some embodiments, the rendering comprises at least one of adding, removing, or updating one or more digital data elements relating to said artifact.

In some embodiments, the raw machine vision digital data signal comprises digital image data from one or more images.

In some embodiments, the artifact corresponds to one or more features in said one or more images.

In some embodiments, the one or more features correspond to at least one of visual features and non-visual features.

In some embodiments, the rendering comprises adding digital data to render non-visual features in said raw machine vision digital data signal into visual features in said transcoded machine vision digital data signal.

In some embodiments, the rendering comprises adding visual elements to said features.

In some embodiments, visual elements comprise text, shapes, colour, texture, or additional images on said one or more images.

In some embodiments, the rendering comprises tagging feature-identifying data with the one or more digital data elements.

In some embodiments, the rendering comprises combining said raw machine vision digital data signal with a further machine vision digital data signal from a further acquisition device.

In some embodiments, the raw machine vision digital data signal comprises, at least in part, non-image data.

In some embodiments, the non-image data comprises sensor output data.

In some embodiments, the digital data processor completes identification of digital data elements and transcoding said transcoded machine vision digital data signal within a latency limit.

In some embodiments, the latency limit provides one of real-time machine vision analysis or near real-time machine vision analysis.

In some embodiments, the digital data processor is further configured to send control signals for controlling functionality of said acquisition device

In some embodiments, the control signals originate from one or more of: the digital data processor or the media consumption device.

In accordance with another aspect, there is provided a computer-implemented functionality deployment method, automatically implemented by one or more digital processors, for deploying functionality on a media acquisition and presentation infrastructure for automated analysis of a substrate, the method comprising: interfacing with at least one media acquisition device that acquires media data and outputs a corresponding raw data media signal to a media consumption device; intercepting said media data signal; identifying digital data elements associated with an artifact of said substrate in said raw data media signal, wherein said artifact is not detectable in said raw data media signal by said media consumption device; applying one or more data transformation function to produce a corresponding transformed media data; transcoding said raw data media signal into a transcoded media data signal by rendering said artifact detectable in said transcoded media data signal by said media consumption device; and transmitting said transcoded media data signal so that it is received by the media consumption device in place of said raw media data signal.

In some embodiments of the method, the media acquisition device and the machine vision consumption device use media formats that are compatible or are the same format.

In some embodiments of the method, the format comprises an ethernet-based communication protocol.

In some embodiments of the method, the ethernet-based communication protocol may be chosen from the following: GigE Vision, USB3 Vision, Camera Link, MIPI or GenICam.

In some embodiments of the method, the rendering comprises at least one of adding, removing, or updating one or more digital data elements relating to said artifact.

In some embodiments of the method, the raw machine vision digital data signal comprises digital image data from one or more images.

In some embodiments of the method, the one or more artifacts correspond to features in said one or more images.

In some embodiments of the method, the features correspond to at least one of visual features and non-visual features.

In some embodiments of the method, the rendering comprises adding digital data to render non-visual features in said raw machine vision digital data into visual features in said transcoded machine vision digital data signal.

In some embodiments of the method, the rendering comprises adding visual elements to said features.

In some embodiments of the method, the visual elements comprise text, shapes, colour, texture, or additional images on said one or more images.

In some embodiments of the method, the rendering comprises tagging feature-identifying data with one or more digital data elements.

In some embodiments of the method, the rendering comprises combining said raw machine vision digital data signal with a further machine vision digital data signal from a further acquisition device.

In some embodiments of the method, the raw machine vision digital data signal comprises, at least in part, non-image data.

In some embodiments of the method, the non-image data comprises sensor output data.

In some embodiments of the method, the digital data processor completes identification of digital elements and transcoding said transcoded machine vision digital data signal within a latency limit.

In some embodiments of the method, the latency limit provides one of real-time machine vision analysis or near real-time machine vision analysis.

In some embodiments of the method, the digital data processor is further configured to send control signals for controlling functionality of said acquisition device

In some embodiments of the method, the control signals originate from one or more of: the digital data processor or the media consumption device.

In accordance with another aspect, there is provided non-transitory computer-readable medium comprising digital instructions to be implemented by one or more digital processors for transcoding a machine vision data signal in an existing machine vision system capturing visual information from a substrate by: receiving a raw machine vision digital signal from an acquisition device, wherein said raw machine vision digital data signal is in a machine vision acquisition device format; identifying digital data elements associated with an artifact in said raw machine vision digital data signal, wherein said artifact is not detectable by said machine vision consumption device; transcoding the raw machine vision digital data signal by rendering the artifact detectable in a transcoded machine vision digital data signal by said machine vision consumption device; outputting the transcoded machine vision digital signal to a consumption device, wherein said transcoded machine vision digital data signal is in a consumption device format.

In some embodiments of the medium, the machine vision acquisition device format and the machine vision consumption device format are compatible or are the same format.

In some embodiments of the medium, at least one of said machine vision acquisition device format and the machine vision consumption device format comprises an ethernet-based communication protocol.

In some embodiments of the medium, the ethernet-based communication protocol may be chosen from the following: GigE Vision, USB3 Vision, Camera Link, MIPI or GenICam.

In some embodiments of the medium, the rendering comprises at least one of adding, removing, or updating one or more digital data elements comprised relating to said artifact.

In some embodiments of the medium, the raw machine vision data signal comprises digital image data from one or more images.

In some embodiments of the medium, the one or more artifacts correspond to features in said one or more images.

In some embodiments of the medium, the features correspond to at least one of visual features and non-visual features.

In some embodiments of the medium, the rendering comprises adding digital data to render non-visual features in said raw machine vision digital signal into visual features in said transcoded machine vision digital data signal.

In some embodiments of the medium, the rendering comprises adding visual elements to said features.

In some embodiments of the medium, the visual elements comprise text, shapes, colour, texture, or additional images on said one or more images.

In some embodiments of the medium, the rendering comprises tagging feature-identifying data with one or more digital data elements.

In some embodiments of the medium, the rendering comprises combining said raw machine vision digital data signal with a further machine vision digital data signal from a further acquisition device.

In some embodiments of the medium, the raw machine vision digital data signal comprises, at least in part, non-image data.

In some embodiments of the medium, the non-image data comprises sensor output data.

In some embodiments of the medium, the digital data processor completes identification of digital data elements and transcoding said transcoded machine vision digital data signal within a latency limit.

In some embodiments of the medium, the latency limit provides one of real-time machine vision analysis or near real-time machine vision analysis.

In some embodiments of the medium, the digital data processor is further configured to send control signals for controlling functionality of said acquisition device

In some embodiments of the medium, the control signals originate from one or more of: the digital data processor or the media consumption device.

Other aspects, features and/or advantages will become more apparent upon reading of the following non-restrictive description of specific embodiments thereof, given by way of example only with reference to the accompanying drawings.

### BRIEF DESCRIPTION OF THE FIGURES

Several embodiments of the present disclosure will be provided, by way of examples only, with reference to the appended drawings, wherein:

FIG. 1 is a schematic diagram of an artificial intelligence (AI) functionality deployment system, in accordance with one embodiment;

FIG. 2 is a schematic diagram of the functionality deployment device of FIG. 1, in accordance with one embodiment;

FIG. 3 is a process flow chart illustrating a method for deploying functionality on an existing monitoring infrastructure, in accordance with one embodiment;

FIGS. 4A and 4B are process flow charts illustrating certain steps of the method of FIG. 3, in accordance with one embodiment;

FIGS. 5A and 5B are schematic diagrams illustrating a QR code detector functionality, in accordance with one embodiment;

FIG. 6 is a schematic diagram illustrating different visual elements that may be recognized or identified by the system of FIG. 1, in accordance with one embodiment;

FIG. 7 is a schematic diagram illustrating a training and configuration system for configuring the functionality deployment device of FIG. 1, in accordance with one embodiment;

FIG. 8 is a process flow chart of an exemplary method for training and configuring a functionality deployment device using the system of FIG. 7, in accordance with one embodiment;

FIGS. 9A and 9B are schematic diagrams illustrating a machine learning hyperspectral imaging application, in accordance with one embodiment; and

FIG. 10 is a schematic diagram of two or more functionality deployment devices networked together in a distributed computing configuration, in accordance with one embodiment.

Elements in the several figures are illustrated for simplicity and clarity and have not necessarily been drawn to scale. For example, the dimensions of some of the elements in the figures may be emphasized relative to other elements for facilitating understanding of the various presently disclosed embodiments. Also, common, but well-understood elements that are useful or necessary in commercially feasible embodiments are often not depicted in order to facilitate a less obstructed view of these various embodiments of the present disclosure.

### DETAILED DESCRIPTION

Various implementations and aspects of the specification will be described with reference to details discussed below. The following description and drawings are illustrative of the specification and are not to be construed as limiting the specification. Numerous specific details are described to provide a thorough understanding of various implementations of the present specification. However, in certain instances, well-known or conventional details are not described in order to provide a concise discussion of implementations of the present specification.

Various apparatuses and processes will be described below to provide examples of implementations of the system disclosed herein. No implementation described below limits any claimed implementation and any claimed implementations may cover processes or apparatuses that differ from those described below. The claimed implementations are not limited to apparatuses or processes having all of the features of any one apparatus or process described below or to features common to multiple or all of the apparatuses or processes described below. It is possible that an apparatus or process described below is not an implementation of any claimed subject matter.

Furthermore, numerous specific details are set forth in order to provide a thorough understanding of the implementations described herein. However, it will be understood by those skilled in the relevant arts that the implementations described herein may be practiced without these specific details. In other instances, well-known methods, procedures and components have not been described in detail so as not to obscure the implementations described herein.

In this specification, elements may be described as “configured to” perform one or more functions or “configured for” such functions. In general, an element that is configured to perform or configured for performing a function is enabled to perform the function, or is suitable for performing the function, or is adapted to perform the function, or is operable to perform the function, or is otherwise capable of performing the function.

It is understood that for the purpose of this specification, language of “at least one of X, Y, and Z” and “one or more of X, Y and Z” may be construed as X only, Y only, Z only, or any combination of two or more items X, Y, and Z (e.g., XYZ, XY, YZ, ZZ, and the like). Similar logic may be applied for two or more items in any occurrence of “at least one . . . ” and “one or more . . . ” language.

Unless defined otherwise, all technical and scientific terms used herein have the same meaning as commonly understood by one of ordinary skill in the art to which this invention belongs.

Throughout the specification and claims, the following terms take the meanings explicitly associated herein, unless the context clearly dictates otherwise. The phrase “in one of the embodiments” or “in at least one of the various embodiments” as used herein does not necessarily refer to the same embodiment, though it may. Furthermore, the phrase “in another embodiment” or “in some embodiments” as used herein does not necessarily refer to a different embodiment, although it may. Thus, as described below, various embodiments may be readily combined, without departing from the scope or spirit of the innovations disclosed herein.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

As used in the specification and claims, the singular forms “a”, “an” and “the” include plural references unless the context clearly dictates otherwise.

The term “comprising” as used herein will be understood to mean that the list following is non-exhaustive and may or may not include any other additional suitable items, for example one or more further feature(s), component(s) and/or element(s) as appropriate.

The systems and methods described herein provide, in accordance with different embodiments, different examples methods and systems for simplifying the deployment of artificial intelligence (AI) capabilities, models or functionalities to improve the reliability and lower the cost of visual quality inspection. Moreover, by using a cost-effective hybrid deployment architecture, such systems and methods may be integrated with existing and advanced sensor sources, including existing inspection hardware and software, while leveraging one or more “plug-in” custom AI skills or functionalities (e.g. classification, sorting, detecting, etc.) to provide a hybrid approach that allows system designers, integrators, and end-users to add more advanced or improved AI capabilities. In other cases, new acquisition devices, such as machine vision acquisition devices, such as cameras, image sensors, or other sensors or detectors, may be incorporated into existing machine vision systems wherein the output of such new acquisition devices are modified, i.e. transcoded, such that the pre-existing machine vision system will accept the output of the new acquisition device as provided to it by existing acquisition devices with which it currently communicates or previously communicated with. Accordingly, new or improved image sensing (or other sensing) capabilities can be incorporated into an existing machine vision system. This includes circumstances in which there is no ability to access or reprogram the software of the existing machine vision system.

While there is considerable interest in AI for vision inspection applications or similar, deployment remains a significant hurdle due to a few key factors. Primarily, new capabilities must fit seamlessly within existing systems where there has been a significant investment in cameras and processing systems. Related to this, there are proven end-user processes that need to be maintained while adding new capabilities. Finally, there is concern that algorithm training is a long, complex, and costly process that requires outside expertise for many companies.

Furthermore, traditional real-time imaging typically relies on transmitting uncompressed data from a camera or sensor back to a central processor for analysis and decision making. This approach poses challenges for designers, particularly as higher bandwidth sensors create a transmission bottleneck and overburden processing capabilities. For example, this may lead to missing frames due to latency issues.

In general, any timing issues in an industrial setting may lead to costly problems and errors, such as a wrong decision being taken, a product being contaminated or damaged or even a wrong or damaged product being sent into production or shipped.

In contrast, the systems and methods described herein, according to different embodiments, rely on known device-to-device networking standards, so as to provide easy integration for Industry 4.0 applications. This may be accomplished by working with existing vision standard-compliant imaging sources and providing built-in machine learning capabilities. Such systems may be relied on to reduce costly inspection errors, false-positives, and secondary screenings that waste human resources and slow processes, for example.

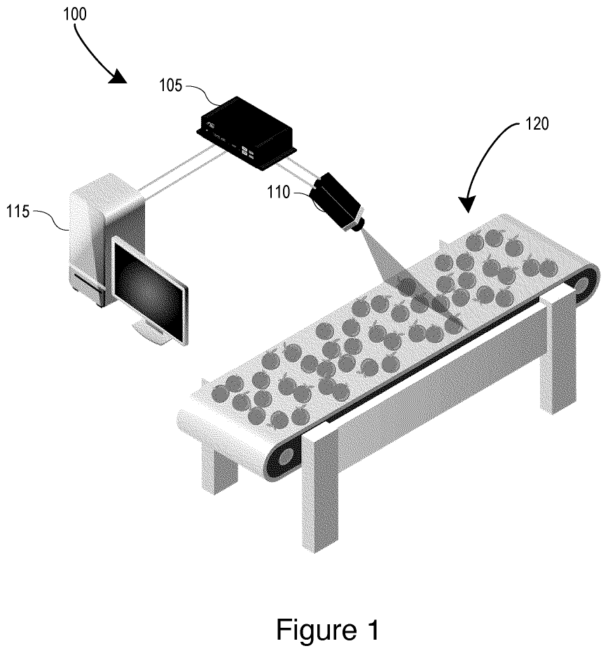

With reference to FIG. 1, and in accordance with one exemplary embodiment, a machine vision functionality deployment system for transcoding a raw machine vision data signal in an existing machine vision system capturing information, for example visual information, from a substrate, generally referred to using the numeral 100, will now be described. In the exemplary embodiment of FIG. 1, system 100 comprises a functionality deployment device 105 which is communicatively linked or integrated between an acquisition device 110 and a consumption device 115. In FIG. 1, acquisition device 110 is illustrated as a camera device configured for viewing/inspecting a substrate (e.g. a series of items or objects, in this example apples) being moved on a conveyor belt. Typically, acquisition device 110 may be deployed in an industrial setting or the like, for factory automation, monitoring and/or inspection, including quality verification or assurance (e.g. QA), for example.

Furthermore, acquisition device 110 may be connected or networked to a consumption device 115 so that the acquired digital image data (e.g. images and/or video, sensor data) may be displayed, viewed and/or recorded by an inspection application running thereon, for example. The inspection application receives the AI processed video as if it were directly connected to the camera, meaning there is no process changes for the end-user.

Generally, any kind of AI skill or functionality may be considered, without restriction, as will be discussed further below. Although in the exemplary embodiment of FIG. 1, the acquisition device 110 is illustrated as a camera, any acquisition device operable and/or configured to acquire data (e.g. images, videos, sensor data, etc.) and transmit a corresponding raw machine vision data signal thereof may be included. This may include, without limitation, cameras, sensors, recording devices or similar. In some embodiments, GigE ethernet-based camera systems or similar may be used. Similarly, consumption device 115 (herein illustrated as a personal computer (PC) as an example only) may be any electronic device operable and/or configured to receive and display said raw machine vision data signal, including monitors, laptops, tablets and/or smartphones.

In some embodiments, system 100 may also be retrofitted to an already existing monitoring infrastructure comprising said acquisition device 110 and said consumption device 115. For example, as illustrated in FIG. 1, device 105 may be configured to act as an intermediary between acquisition device 110 and a consumption device 115. Device 105 may be configured to intercept a camera video feed acquired and transmitted by acquisition device 110 and apply thereon one or more media transformation or functionality, including in some embodiments one or more AI skill or functions. This may include identifying digital data elements associated with a visual artifact (e.g. features and/or elements present in data) in the raw machine vision digital data signal that would not normally be detectable by consumption device 115. In some embodiments, device 105 may thus be operable to intercept or receive an raw machine vision data signal originating from acquisition device 110 in its original machine vision acquisition device format and retransmit a transcoded machine vision digital data signal in a consumption device format and thus operable to be received by the consumption device 115 but comprising therein a transformed data, so that media consumption device 115 may be operable to receive and display the data contained therein without any additional configuration. Thus, in this example, consumption device 115 receives the transcoded media data signal from device 105 as if it came directly from media acquisition device 105. In general, functionality deployment device 105 may be configured to apply any kind of transformations or functions to the raw machine vision digital data signal, for example overlaying or adding visual elements providing additional information about features or elements present within the received data (e.g. images or video images). For example and without limitation, one functionality or function that may be provided by device 105 includes applying an image segmentation analysis to an intercepted or received image so as to pre-process or “focus” a visual inspection application to improve results and reduce false-positives. In some embodiments, the consumption device format may be the same format as the input machine vision acquisition device format or at least be compatible therewith.

In some embodiments, acquired data may be accessed and, utilizing data analysis techniques that are not available to existing machine vision analysis systems that have already been installed, e.g. in a factory or manufacturing facility, image analysis may be improved without having access to the pre-existing machine vision system analysis component or its software. Improved image or sensor data analysis may be applied using embodiments disclosed herein, for example, wherein improved methodologies or functionalities for analyzing are developed independently of those that were previously available at the time of installation or acquisition of an existing machine vision system. In many cases, the software of such existing machine vision systems is not available to be modified due to its proprietary nature, or because the software is complex and requires specialized knowledge or expertise. In embodiments hereof, improved data analysis techniques, including for example machine learning, neural nets, and artificial intelligence may be utilized to analyze image data and, based on such analysis, modification of the analyzed image data such that (a) certain characteristics relating to the improved data analysis may be augmented or emphasized; and (b) the pre-existing machine vision consumption device will accept the modified image data as if received directly from an existing acquisition device that is otherwise compatible with the consumption device. In some embodiments, the improvement analysis will comprise a similar analysis to that being conducted by the existing consumption device, but it will be improved or tuned to improve the results or effectiveness of the analysis. In some cases, a different or additional data analysis will be applied. In some embodiments, a retrofitted or new data acquisition device may be utilized (e.g. an image sensor capturing different light wavelengths or optical characteristics than the installed image sensor device) and the output may be transcoded so as to be accepted by the existing consumption device as if received directly from an existing acquisition device that is otherwise compatible with the consumption device. In addition to improved data analysis, alternative types of data analysis of captured image data (or other sensed data) may be utilized. In some embodiments, image segmentation or object detection (or improved segmentation or object detection methods) may be made available as, for example, a plug-in or added feature, wherein the improved segmentation or object definition is used to augment the image data or other sensor data. The augmented data is transcoded into a format compatible with the existing system, but is now more effectively and/or accurately analysed by the installed machine vision analysis system. In some embodiments, the existing software continues to operate without modification (or needing to be modified). In some cases, transcoded image or sensor data may be cloned; in some cases, such cloned data may result in “camera” or other image data sensor being cloned. In some embodiments, there may be image enhancement to improve image analysis or image data analysis wherein existing image data is enhanced to make the previously installed image analysis system and/or its software perform data analysis more effectively. This might include an improved ability to distinguish between objects or segments in an image more accurately and/or correctly.

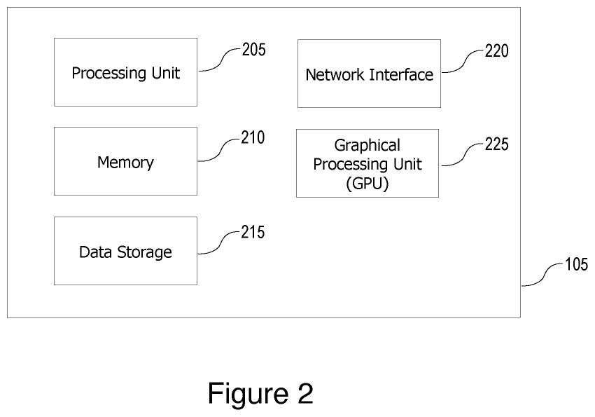

As shown in FIG. 2 and according to one embodiment, functionality deployment device 105 may comprise a digital data processor 205, and communicatively linked thereto internal memory 210, a data storage unit 215, and a Network Interface or digital data interface bus 220. In some embodiments, functionality deployment device 105 may further comprise one or more graphical processing unit (GPU) 225 for adding processing power.

Internal memory 210 can be any form of volatile electronic memory, including random-access memory (RAM) or similar. Data storage unit 215 may include any non-volatile data storage known in the art, including disk drives (DVD, Blu-ray, etc.), hard drives, Flash drives, MicroSD cards, and others.

Network interface or digital data interface bus 220 may comprise a network adapter or similar and one or more input/output ports. These input/output ports may include network ports (e.g. such as ethernet ports or similar) or any kind of analog or digital connection ports. Network interface 220 is generally operable to encode/decode a plurality of signal formats or protocols, including transcoding signals from one format or protocol to another. In some embodiments, it may also be operable to provide digital to analog or analog to digital conversions. Furthermore, in some embodiments, network interface 220 may be configured to use any ethernet-based communication protocol known in the art, without limitation. These interface protocols may include, without limitation: GigE Vision, USB3 Vision, Camera Link and MIPI. For example, device 105 may be operable, via network interface 220, to convert an input raw machine vision digital data signal 402 received from a CameraLink-compatible acquisition device 105 to packets and re-transmit it in a transcoded machine vision digital data signal 412 over GigE with low, predictable latency. In some embodiments, network interface 220 may leverage the computational power of GPU 225 to, at least in part, encode/decode or transcode said data signals.

In some embodiments, specific latency requirements may be required. Such latency requirements may be associated with a specific task, including machine-vision tasks (e.g. sorting, identifying, or characterizing units passing by on a high-speed conveyor, including where the high-speed conveyor has variable speed, and/or where there are a high and/or variable number of units passing by the acquisition device). In some cases, the latency may be expressed as both or either of communication and processing time, and in some cases it may be expressed as a minimum time (although it may be expressed in non-time domain contexts). As used herein, “latency” can be used to refer to a measure of the amount of time required to communicate and/or process data collected and analyzed by a machine vision system. Another related concept, is that of “throughput”. As used herein, “throughput” may refer to the number of specific operations that a machine vision system must process per unit time; for example, it must identify and characterize 10,000 apples passing by a sensory acquisition device every minute. Throughput may be expressed as a number of processing requirements or steps per unit time (or other denominator for non-time domain contexts). These may be competing notions and, therefore, machine vision systems may refer to latency requirements at specific throughput conditions or as a function of such throughput conditions, or it may require maintaining latency irrespective of throughput requirements. Latency and/or throughput requirements may be specified by a user or determined automatically (e.g. programmatically or via AI-based machine learning based on achieving or avoiding specific outcomes or criteria). In some embodiments, the functionality deployment device may be configured to improve latency (and/or throughput) of the system by rendering the media data signal easier to process by the consumption device. For example, it may render sub-par apples in a specific format that is easier (i.e. quicker) for the consumption device to identify as being sub-par or adequate. In some embodiments, the pre-determined or automatically determined latency limits (and/or, if applicable, the throughput limits) are implemented by the system as a preferred range, upper or lower limits, or multiple (i.e. first, second, and third thresholds) such that warnings can be raised or other additional processing/communication resources can be automatically brought to bear. In some cases, a plurality of functionality deployment devices may be deployed for a single set or sets of acquisition and consumption devices, thereby parallelizing the deployed functionality and significantly improving latency and/or throughput (e.g. portions of an image can be analyzed by each of a plurality of functionality deployment device such that an entire image can be analysed faster).

In some embodiments, device 105 via network interface 220 may be operable to act like any vision standard-compliant device, and may provide for example GigE Vision, USB3 Vision, and/or GenICam (e.g. “Generic Interface for Cameras standard”) access to all of the settings of pre-installed cameras or sensors to maintain compatibility with existing applications.

Furthermore, network interface 220 may support a plurality of APIs known in the art for interacting and/or controlling cameras and sensors. Thus, device 105 is not limited to or locked-in a designated hardware/software environment, but may instead operate with or between different hardware/software environments as needed, as will be discussed below.

In some embodiments, network interface 220 may be operable to interface with two or more media acquisition units 105, and/or to transmit to two or more consumption devices 115, simultaneously.

In some embodiments, GPU 220 may be an embedded GPU chip or/and be comprised within a video card or similar. In some embodiments, GPU may comprise two or more GPUs. These may be configured, in some embodiments, in a parallel configuration or similar. Some examples GPUs include, without limitation, an NVIDIA Jetson TX2i GPU or similar.

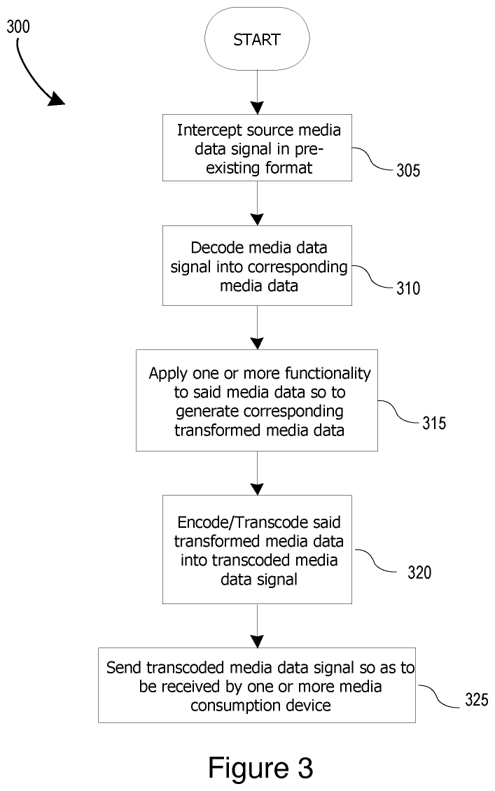

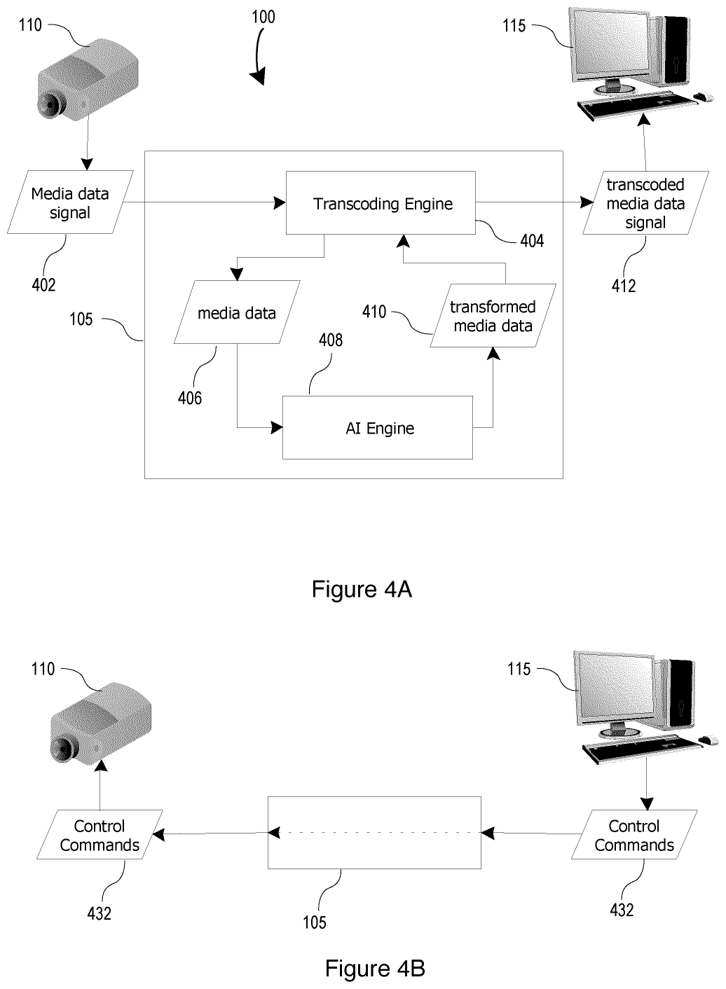

With reference to FIG. 3, and in accordance with one exemplary embodiment, a method for deploying functionality on existing media acquisition and presentation configurations using functionality deployment device 105, generally referred to using the numeral 300, will now be described. As mentioned above, at step 305, functionality deployment device 105 may be deployed and configured so as to intercept incoming an incoming or input media data signal transmitted from a media acquisition device 105. In some embodiments, media acquisition device 105 may have been previously installed (i.e. in a retrofit application or similar), or alternatively it may be a new device but for which consumption device 115 is not configured to receive a media data signal therefrom. This is illustrated schematically in FIG. 4A, wherein a raw machine vision digital data signal 402 is shown being transmitted from acquisition device 110 and intercepted by functionality deployment device 105 via a transcoding engine 404. This transcoding engine 404 may be hardware-based, software-based or any combination thereof, and configured to leverage network interface 220 to receive and at step 310 decode raw machine vision digital data signal 402 (e.g. digital/analog signal), so as to extract therefrom the associated data 406 (e.g. sensor data, camera images and/or video, etc.). In some embodiments, transcoding engine 404 may configured remotely via the use of one or more software modules and/or plug-ins.

Once data 406 is obtained, at step 315, one or more function is applied thereto. For example, in FIG. 4A, data 406 is sent to an AI engine 408 so as to be transformed or altered into transformed data 410. In some embodiments, these transformations may be derived from or aided by AI applications or models, including machine learning (ML) applications such as deep neural networks and/or image software applications executed on digital data processor 205 and/or GPU 220. In some embodiments, as will be discussed below in more details, AI engine 408, like transcoding engine 404, may also be configured and/or programmed remotely via the use of one or more software modules or plug-ins, for example to address various sensor interfaces.

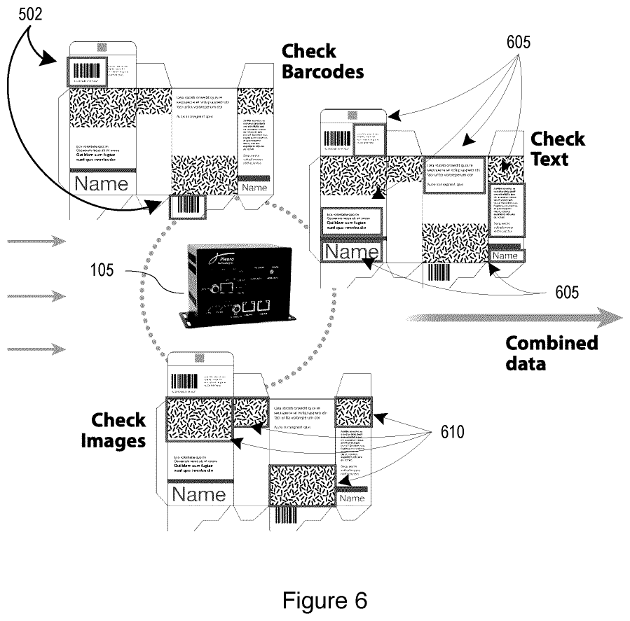

In some embodiments, AI engine 408 may be configured to automatically apply one or more AI skill or functionality to data 406. This may include machine vision functionalities such as automated recognition of one or more features or subset of features present in data 406. As illustrated in FIG. 6, data 406 may for example be an image of a box having a label or sticker thereon. Thus, AI engine 408 may be configured to automatically identify or read different elements or features on this label, for example barcodes 502, text 504 and/or one or more subset images 506. In some embodiments, different types of AI analysis and/or functions may be applied on data 406, either sequentially or in parallel, and the information extracted from each individual function may be combined to produce new information (for example combining information from barcode 502, text 504 and image 506 to identify a specific product or item, or any information related thereto directly or indirectly). Any kind of AI skills or functionality may be provided, without limitation, and these may be deployed, in some embodiments, in the form of individual software packages or applications called plug-in modules, as will be discussed below in more detail.

In some embodiments, some modules or plug-ins may be used configure consumption device 115 the so that it may receive inputs from new acquisition devices 105 (e.g. new cameras, sensors, etc.).

Returning to FIG. 3, once data 406 has been transformed or altered into transformed data 410, at step 320 it may be re-encoded or transcoded before being sent out at step 325 to be received by consumption device 115. This is further illustrated schematically in FIG. 4A wherein transformed data 410 is shown being sent back to the transcoding engine 404 to be encoded/transcoded into transcoded data signal 412 and to be sent out therefrom and received by consumption device 115. As discussed above, in some embodiments, the encoding/transcoding may be applied so that transcoded data signal 412 has the same format or encoding as the intercepted data signal 402. Thus, as mentioned above, a pre-installed consumption device 115 would not need to be re-configured or replaced to be able to receive and display transcoded machine vision digital data signal 412.

In some embodiments, and as illustrated schematically in FIG. 4B, device 105 may be operable to let interaction and/or control signals originating from consumption device 115 to pass through without interference so that they may be received by media acquisition device 105. Indeed, as mentioned above, any APIs known in the art for interacting and/or controlling cameras and sensors may be supported. For example, in some cases, commands that may be sent out from consumption device 115 may include changes in orientation (e.g. moving/panning a camera), zooming out/in, programming or changing the configuration of acquisition device 110 or the like. Therefore, not only does consumption device 115 “not aware” of the presence of device 105, acquisition device 105 itself may receive commands/instructions from media consumption device 115 as if it were connected directly to it.

Similarly, in some embodiments, functionality deployment device 105 may itself be further operable to issue commands/instructions to acquisition device 105, as discussed above. In some embodiments, the functionality deployment device 105 can generate such control signals itself, or pass on control signals from another component, such as the media consumption device 115, another functionality deployment device, or another computing device communicatively connected with the functionality deployment device 105. Accordingly, control over a media acquisition device 105, such as causing additional or reduced image capture, changing focus or field of view, changing colour or light capture characteristics, can be implemented by control signals originating from the functionality deployment device 105. Control signals originating from the functionality deployment device 105 can be the result of programmatic or AI functionality (e.g. as a result or occurrence of a predetermined event or state, or upon the AI functionality “learning” or recognizing that different functionality would be beneficial to system goals). Alternatively or in addition, such control signals may be passed on, modified, or suspended/blocked by the functionality deployment device 105 (in some cases based on programmatic or AI functionality). In some embodiments, a user interface associated with the functionality deployment device 105 allows a user to provide control signals to cause or change functionality of the media acquisition device 105; in some cases, such control signals may not be available in or via the media consumption device 115 without additional reprogramming or replacement of the media consumption device 115. Control signal propagation may be done via for example by AI engine 406, via one or more modules as discussed below.

In some embodiments, when media data 406 comprises an image, the image may be enhanced (e.g. into transformed data 410) by the addition of additional visual features or elements thereto. For example, an input image may comprise features or elements identified by AI engine 408. To display the result of this analysis, AI engine 408 may thus transform the input image by adding or superimposing thereto additional visual elements so as to display these results or information related thereto. This may include, without limitation, the addition of text, images and/or shapes (e.g. squares, circles, triangles, arrows, etc.) on the image. For example, in some embodiments, shapes may be used to better identify the presence of certain features, artifacts or elements, for example by tagging (i.e. putting a rectangle or circle around it) an object or parts of an object. Text may be added, for example, above the identified element to provide further information, such as an identification label or to name a problem identified therewith. Images may be added to acquired data by, for example, generating one or more of the following: graphs, tables, diagrams, heatmaps, new images, overlays onto preexisting or alternatively acquired image data, or other graphical information; and then adding such information to acquired data that may constitute, for example, only or in part textual or digital information to which the generated image data can be added. Thus, a person monitoring the display on consumption device 115 would instantly see the results by simply looking at the image.

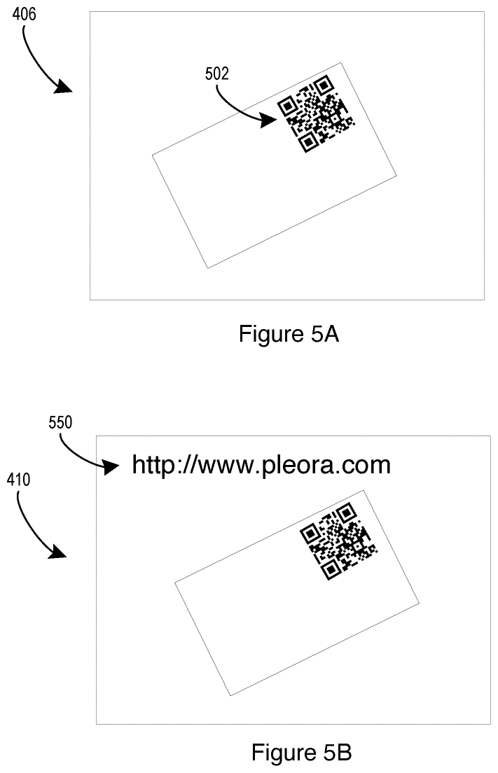

FIGS. 5A and 5B show an example, according to one embodiment, of data 406 being transformed into a transformed data 410. In this example, acquisition device 110, in this case a camera, sends a raw machine vision digital data signal 402 comprising embedded therein an image (e.g. data 402), which in this example is an image of a package or object having a QR code 502 thereon (for example on a label or similar). By using a QR code detector plug-in module deployed and executed on AI engine 408, device 105 may be operable to output a transcoded machine vision data signal 412 comprising therein an enhanced image (e.g. transformed data 410), which is shown in FIG. 4B, wherein the content of QR code 502 (e.g. the web address: “http://www.pleora.com”) has been textually superimposed onto the original image. Thus, an individual or person monitoring consumption device 115 would immediately see the contents of the QR code in the image without having to do any extra work to decode it.

In some embodiments, transformed data 410 may be derived or generated from combining a plurality of visual features or elements. In some embodiments, one or more subsets, elements or artifacts of said data extracted/identified/read via one or more AI functionality may be combined. For example, as illustrated in FIG. 6, information extracted from barcodes 602, text 604 and/or images 610 on an exemplary packaging label or similar, or any combination thereof, may readily be combined.

However, data 406 does not have to be an image or similar. In some embodiments, as mentioned above, acquisition device 110 may be a sensor or data acquisition device providing analog or digital data. This may include, without limitation, heat or temperature sensors, light sensors (IR, NIR, visible or UV), motion detectors, mechanical stress sensors, pressure sensors or similar. Thus, in some embodiments, this non-visual data may also be used by AI engine 408. For example, visual elements like tables, plots, graphics and/or diagrams derived from such sensor data may be added or superimposed on data 406 comprising an image or video. In other cases, non-visual data 406 may be used to derive non-visual outputs to consumption device 115, for example in some cases to send back commands/instructions to acquisition device 110.

In some embodiments, more than one acquisition device 110 may be connected or networked into functionality deployment device 105 simultaneously. For example, device 105 may be operable to generate transformed data 410 image by combining data 402 from two or more raw machine vision data signals 402.

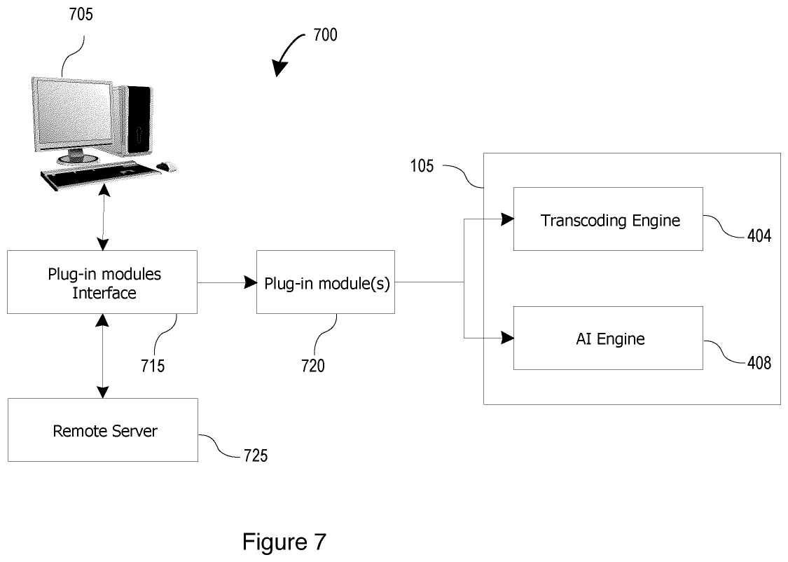

With reference to FIG. 7, and in accordance with different embodiments, a training and configuration framework or system for configuring device 105 of system 100, generally referred to the numeral 700, will now be described. This training and configuration framework or system may be used to program or configure the capabilities or functionalities deployed via transcoding engine 404 and/or AI engine 408 of a given device 105. In system 700, according to one embodiment, a networked computer device 705 (e.g. PC, laptop, etc.) connected to device 105 may have access to a plug-in module interface 715, said interface being operable to configure and/or load one or more plug-in module(s) 720 to be executed by transcoding engine 404 and/or AI engine 408 of device 105. In the case of transcoding engine 404, this may include adding or configuring various camera/sensor interfaces, APIs, etc., while in the case of AI engine 408, this may include incorporating one or more AI model or skill.

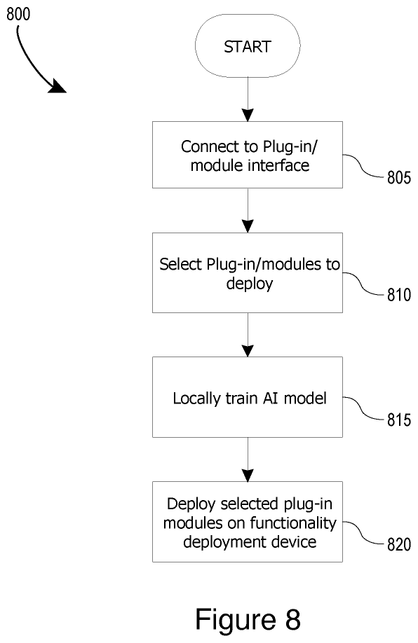

With reference to FIG. 8, and in accordance with different embodiments, a configuration method for configuring device 105 using system 800, generally referred to by the numeral 800, will now be described. As mentioned above, initially a user or developer connects a computing device 705 to plug-in module interface 715. In some embodiments, said plug-in module interface 715 may said interface be implemented as a dedicated software application running or being executed on computing device 705 or as a web-based application (e.g. comprising a web-browser based interface for example).

At step 810, the user or developer may choose or select which plug-in module and associated AI functionality to deploy. In some embodiments, user interactions with plug-in module interface 715 may be done via a graphical user interface (GUI) or similar so that the connected user or developer may deploy AI skills functionality without any additional programming knowledge. In some embodiments, an assortment of pre-loaded module(s) 720 may be made available via interface 715 and loaded as required.

Moreover, in some embodiments, choosing, training and configuring a given module may only require clicking on boxes/buttons/text via a mouse, trackpad or similar. In some embodiments, more than one plug-in module 720 may be chosen to work together sequentially or in parallel to achieve more complex tasks.

In some embodiments, plug-in module interface 715 may also include out-of-the-box solutions and sample code to allow end-users and developers to add intelligence to visual inspection applications and simplify the deployment of customized capabilities.

In some embodiments, plug-in module interface 715 may provide a framework or Software Development Kit (SDK) to allow for custom plug-in modules 720 to be written therefor and uploaded thereto. These may be written or programmed in different programming languages, including but not limited to the Python computing language. For example, plug-in modules may be written in Python using open source libraries to run on a custom operating system (OS) for custom AI applications.

In some embodiments, examples or sample code may be provided to help users or developers create their own custom plug-in module 720. In some embodiments, open source or custom algorithms developed in popular frameworks

In some embodiments, plug-in module interface 715 may offer a number of pre-trained or built-in plug-in modules 720.

In some embodiments, the AI model of a plug-in module may comprise one or more machine learning or computer vision algorithms using neural networks, such as supervised learning techniques and/or unsupervised learning techniques. In some embodiments, deep learning algorithms may be used, including, but not limited to, recurrent neural networks, recursive neural networks, feed-forward neural networks, convolutional neural networks, deep belief networks, convolutional deep belief networks or similar. In some cases, the plug-in module may be made available with the deep learning model pre-trained.

Alternatively or additionally, in some embodiments, plug-in module interface 715 may further comprise a training software or the like configured to custom train a chosen AI model of a given plug-in module 720. Thus, optionally, at step 815, a user may locally train a selected AI model generated by a chosen plug-in module of plug-in module interface 715. For example, a user may upload images or data to plug-in module interface 715 running on computing device 705, so that they may be used to train locally a neural network-based computer vision application. Plug-in module interface 715 may generate for example a neural network, train it locally before deployment.

Finally, at step 820, the chosen plug-in modules 720 may be deployed via plug-in module interface 715 into a selected and connected functionality deployment device 105 so that it may be used.

In some embodiments, plug-in module interface 715 may further be operable to connect to a remote server 725, for example to fetch/retrieve or update therefrom one or more module. In some embodiments, plug-in modules may include any image processing algorithm to improve or enhance an input image. For example, and without limitation, these may include image filters for smoothing or sharpening, noise removal, improving contrast, or the like. In some embodiments, additional image processing may be implemented in order to inject additional data into acquired image data (or other sensor data) in order to make existing decision algorithms more effective and/or more correct. The additional data that is injected from additional image processing may include new or different machine learning methodologies to better automatically detect image characteristics, or it may include the same machine learning methodologies but improved ML learning or tuning. In embodiments, the additional image processing may include different functionalities, such as image segmentation, object detection, feature detection, or feature edge detection. Image segmentation generally refers to the process of partitioning a digital image into multiple segments (sets of pixels, also known as image objects), often with a goal of simplifying and/or changing the representation of an image into something that is more meaningful and easier to analyze. Image segmentation may be used to locate objects and boundaries (lines, curves, etc.) in images. In some cases, image segmentation may refer to the process of assigning a label to every pixel in an image such that pixels with the same label share certain characteristics. The result of image segmentation may, in some embodiments, provide a set of segments that collectively cover an entire image, or a set of contours extracted from an image, which may provide edge detection of features or objects represented in an image or in image data. In some cases, each of the pixels in a region or in an image that share some characteristic or computed property, such as color, intensity, or texture (or indeed some other optically or non-optically sensed characteristics) may tagged or indexed to be represented in a similar fashion (or otherwise be similarly detected and associated by existing installed data analysis systems).

In some embodiments, plug-in interface 715 may include machine vision applications, such as region/edge/line detection algorithms to detect region of interest, image enhancement algorithms, geometry transform algorithms, region of interest selection, object recognition, feature selection, classification, and sorting; object numbering, etc.

For example, one or more plug-in module(s) 720 may provide the ability to detect or identify, without limitation, surface defects or discontinuities, identifying foreign objects/materials and/or missing components, or similar in an input image. In some embodiments, machine vision applications may be used to inspect or monitor machined components (e.g. the presence of cracks, changes in material quality).

In some embodiments, plug-in interface 715 may be operable to deploy TensorFlow, OpenCV applications.

In some embodiments, an inspection plug-in module may be provided. For example, an inspection plug-in module may be used to simplify the deployment of deep learning-based classification, segmentation, and object detect capabilities for visual inspection applications. This may support an “auto-learning” mode with predefined parameter optimized for GPU 225.

In some embodiments, plug-in modules interface 715 may provide an object counter plug-in module. This module may provide the functionality of recognizing certain objects in an input image and count them. For example, it may be operable to detect circles in an input image (e.g. data 406), count them and superimpose the live count on the output image (e.g. transformed data 410). Thus, this plug-in module may be used to automate routine counting tasks.

In some embodiments, plug-in modules interface 715 may provide an image comparison plug-in module. For example, this module or plug-in may provide the functionality of comparing two images, a reference image and a current image to be inspected. This module, in some embodiments, may be operable to automatically highlight defects or discrepancies present on the current image, thus automating routine visual inspection tasks.

In some embodiments, plug-in module interface 715 may provide a per-pixel inversion plug-in module. For example, this plug-in module may be operable to invert the pixel values of an input image.

In some embodiments, plug-in modules of plug-in module interface 715 may be configure both transcoding engine 404 and AI engine 408. For example, in the pharmaceutical market, hyperspectral imaging can be used to detect subtle changes in the composition of active ingredients in visually identical pills to screen out-of-specification products. However, such cameras typically generate hyperspectral data which, in some instances, may not be readily displayed by a typically consumption device 115 (e.g. monitor or pre-existing machine vision application running on a computing device or similar). However, using plug-in module interface 715, transcoding engine 404 may be easily configured to receive a raw machine vision data signal 402 from a hyperspectral camera (e.g. for example in a camera link format) and convert it into a transcoded machine vision digital data signal 412 (for example into the form a GigE vision stream) which may be readily displayed by consumption device 115. Additionally, one or more AI skills or functions may be automatically applied on the hyperspectral images as well, via the use of one or more machine vision module or similar by AI engine 408.

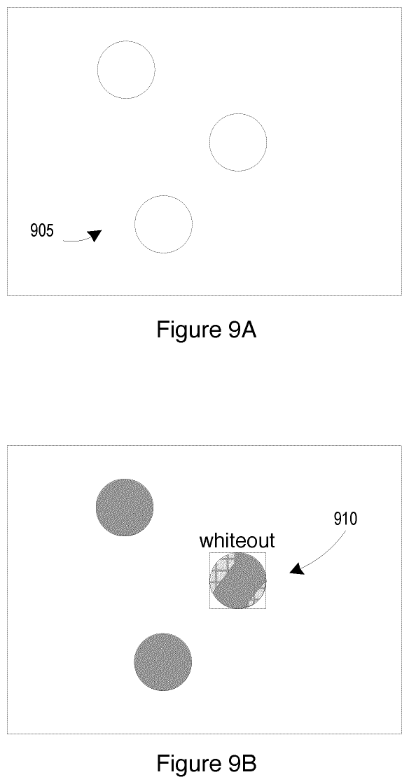

FIGS. 9A and 9B show schematically such an example, according to one embodiment. In this example, FIG. 9A illustrated diagrammatically an exemplary image acquired by a typical camera of a plurality of pills 905 moving on a conveyor belt or similar. Herein, each one of pills 905 has a white paint coating to be inspected. Typically, it may be difficult to clearly identify defective coatings via simple visual inspection, for example with a normal camera. Thus, it may be desirable to use a hyperspectral camera (e.g. SPECIM FX17 or similar) since the generated hyperspectral data in the MR (900 to 1700 nm) would provide signatures of the presence of different ingredients or substances on the surface of each pill. Normally, such a camera may not be easily integrated into an existing monitoring system because for example it may not be able to interpret multiband information.

Thus, a given functionality deployment device 105 may have deployed thereon a hyperspectral camera module operable to bridge the gap between applications and existing machine vision software by automatically handling image acquisition from the hyperspectral imaging source and sending out the processed data over GigE Vision to consumption device 115. FIG. 9B, shows the transformed data 410 generated via this exemplary hyperspectral imaging module comprising an AI model trained to detect coating defects from the hyperspectral data. Thus, herein the model (for example a perClass Mira® model or similar) has detected for example that pill 910 has a defective coating. The image received by consumption device 115 thus shows both a color image derived from said multispectral data showing different ingredients (e.g. paint, sugar, whiteout) but also superimposed on the defective pill 910 a square indicator clearly identifying the pill and adding a “whiteout” message just above it indicating the nature of the problem. Thus, in the output image (i.e. transformed data 410), paint, whiteout and sugar are easily differentiated and viewed in this example as a regular GigE Vision camera stream (i.e. transcoded machine vision digital data signal 412) on consumption device 115.

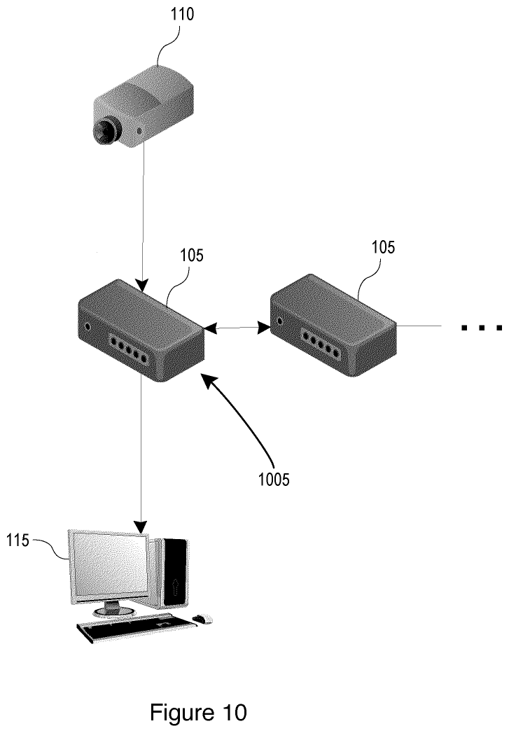

In some embodiments, system 100 may comprise two or more functionality deployment devices 105 deployed in a distributed computing configuration or similar. An example of this, in accordance with one embodiment, is illustrated schematically in FIG. 10. Therein, system 100 comprises two or more functionality deployment devices 105 connected or networked together in a mesh network so as to distribute the work or computational load across multiple devices. In this example, one of the devices 105 may act as a master hub device 1005, and may be configured to both receive media data signal 402 from media acquisition device 105 and send the transcoded machine vision digital data signal 412 to consumption device 115. In addition, master device 1005 may further be operable to distribute one or more computing tasks to other connected devices 105. The workload may be divided in different ways, without limitation. For example, a single computing task may be distributed across multiple devices 105, and/or distinct tasks may be allocated to each device 105. For example, each individual device 105 may be configured to detect or identify distinct features (e.g. different defects types, etc.) in an input image (i.e. media data 402). The results from each non-master device 105 may be sent back to master device 1005 and combined thereon, so as to generate the transcoded machine vision digital data signal 412. The skilled technician will appreciate that any communications protocol or combination of communications protocols that may facilitate inter-device communication between each device 105 known in the art may be used.

While the present disclosure describes various embodiments for illustrative purposes, such description is not intended to be limited to such embodiments. On the contrary, the applicant's teachings described and illustrated herein encompass various alternatives, modifications, and equivalents, without departing from the embodiments, the general scope of which is defined in the appended claims. Except to the extent necessary or inherent in the processes themselves, no particular order to steps or stages of methods or processes described in this disclosure is intended or implied. In many cases the order of process steps may be varied without changing the purpose, effect, or import of the methods described.

Information as herein shown and described in detail is fully capable of attaining the above-described object of the present disclosure, the presently preferred embodiment of the present disclosure, and is, thus, representative of the subject matter which is broadly contemplated by the present disclosure. The scope of the present disclosure fully encompasses other embodiments which may become apparent to those skilled in the art, and is to be limited, accordingly, by nothing other than the appended claims, wherein any reference to an element being made in the singular is not intended to mean “one and only one” unless explicitly so stated, but rather “one or more.” All structural and functional equivalents to the elements of the above-described preferred embodiment and additional embodiments as regarded by those of ordinary skill in the art are hereby expressly incorporated by reference and are intended to be encompassed by the present claims. Moreover, no requirement exists for a system or method to address each and every problem sought to be resolved by the present disclosure, for such to be encompassed by the present claims. Furthermore, no element, component, or method step in the present disclosure is intended to be dedicated to the public regardless of whether the element, component, or method step is explicitly recited in the claims. However, that various changes and modifications in form, material, work-piece, and fabrication material detail may be made, without departing from the spirit and scope of the present disclosure, as set forth in the appended claims, as may be apparent to those of ordinary skill in the art, are also encompassed by the disclosure.

What is claimed is:

1. A machine vision functionality deployment system for transcoding a raw machine vision data signal in an existing machine vision system capturing sensed information from a substrate, the system comprising:
a digital data interface bus that is operable to:
receive said raw machine vision digital data signal from an acquisition device, wherein said raw machine vision digital data signal is in an acquisition device format;
output a transcoded machine vision digital data signal to a consumption device, wherein said transcoded machine vision digital data signal is in a consumption device format;
a digital data processor communicatively linked to said digital data interface bus, and said digital data processor operable to:
identify digital data elements associated with an artifact of said substrate in said raw machine vision digital data signal, wherein said artifact is not detectable by said consumption device;
transcode the raw machine vision digital data signal by rendering the artifact detectable in the transcoded machine vision digital data signal by said consumption device.

2. The system of claim 1, wherein said acquisition device format and the consumption device format are compatible or are the same format.

3. The system of either one of claim 1 or claim 2, wherein at least one of said acquisition device format and the consumption device format comprises an ethernet-based communication protocol.

4. The system of claim 3, wherein said ethernet-based communication protocol is: GigE Vision, USB3 Vision, Camera Link, MIPI, or GenICam.

5. The system of any one of claims 1 to 4, wherein said rendering comprises at least one of adding, removing, or updating one or more digital data elements relating to said artifact.

6. The system of claim 5, wherein the raw machine vision digital data signal comprises digital image data from one or more images.

7. The system of claim 6, wherein the artifact corresponds to one or more features in said one or more images.

8. The system of claim 7, wherein the one or more features correspond to at least one of visual features and non-visual features.

9. The system of claim 8, wherein said rendering comprises adding digital data to render non-visual features in said raw machine vision digital data signal into visual features in said transcoded machine vision digital data signal.

10. The system of either one of claim 7 or claim 8, wherein said rendering comprises adding visual elements to said features.

11. The system of claim 10, wherein said visual elements comprise text, shapes, colour, texture, or additional images on said one or more images.

12. The system of any one of claims 1 to 4, wherein said rendering comprises tagging feature-identifying data with the one or more digital data elements.

13. The system of claim 1, wherein said rendering comprises combining said raw machine vision digital data signal with a further machine vision digital data signal from a further acquisition device.

14. The system of any one of claims 1 to 13, wherein the raw machine vision digital data signal comprises, at least in part, non-image data.

15. The system of claim 14, wherein said non-image data comprises sensor output data.

16. The system of any one of claims 1 to 15, wherein said digital data processor completes identification of digital data elements and transcoding said transcoded machine vision digital data signal within a latency limit.

17. The system of claim 16, wherein said latency limit provides one of real-time machine vision analysis or near real-time machine vision analysis.

18. The system of any one of claims 1 to 17, said digital data processor is further configured to send control signals for controlling functionality of said acquisition device.

19. The system of claim 18, wherein the control signals originate from one or more of: the digital data processor or the media consumption device.

20. A computer-implemented functionality deployment method, automatically implemented by one or more digital processors, for deploying functionality on a media acquisition and presentation infrastructure for automated analysis of a substrate, the method comprising:
interfacing with at least one media acquisition device that acquires media data and outputs a corresponding raw data media signal to a media consumption device;
intercepting said media data signal;
identifying digital data elements associated with an artifact of said substrate in said raw data media signal, wherein said artifact is not detectable in said raw data media signal by said media consumption device;
applying one or more data transformation function to produce a corresponding transformed media data;
transcoding said raw data media signal into a transcoded media data signal by rendering said artifact detectable in said transcoded media data signal by said media consumption device; and
transmitting said transcoded media data signal so that it is received by the media consumption device in place of said raw media data signal.

21. The method of claim 20, wherein said media acquisition device and the machine vision consumption device use media formats that are compatible or are the same format.

22. The method of either one of claim 20 or claim 21, wherein said format comprises an ethernet-based communication protocol.

23. The method of claim 22, wherein said ethernet-based communication protocol is GigE Vision, USB3 Vision, Camera Link, MIPI, or GenICam.

24. The method of any one of claims 20 to 23, wherein said rendering comprises at least one of adding, removing, or updating one or more digital data elements relating to said artifact.

25. The method of claim 24, wherein the raw machine vision digital data signal comprises digital image data from one or more images.

26. The method of claim 25, wherein the one or more artifacts correspond to features in said one or more images.

27. The method of claim 26, wherein the features correspond to at least one of visual features and non-visual features.

28. The method of claim 27, wherein said rendering comprises adding digital data to render non-visual features in said raw machine vision digital data into visual features in said transcoded machine vision digital data signal.

29. The method of claim 27, wherein said rendering comprises adding visual elements to said features.

30. The method of claim 29, wherein said visual elements comprise text, shapes, colour, texture, or additional images on said one or more images.

31. The method of any one of claims 20 to 23, wherein said rendering comprises tagging feature-identifying data with one or more digital data elements.

32. The method of claim 20, wherein said rendering comprises combining said raw machine vision digital data signal with a further machine vision digital data signal from a further acquisition device.

33. The method of any one of claims 20 to 32, wherein the raw machine vision digital data signal comprises, at least in part, non-image data.

34. The method of claim 33, wherein said non-image data comprises sensor output data.

35. The method of any one of claims 20 to 34, wherein said digital data processor completes identification of digital elements and transcoding said transcoded machine vision digital data signal within a latency limit.

36. The method of claim 35, wherein said latency limit provides one of real-time machine vision analysis or near real-time machine vision analysis.

37. The method of any one of claims 20 to 36, wherein said digital data processor is further configured to send control signals for controlling functionality of said media acquisition device.

38. The method of claim 37, wherein the control signals originate from one or more of: the digital data processor or the media consumption device.

39. A non-transitory computer-readable medium comprising digital instructions to be implemented by one or more digital processors for transcoding a machine vision data signal in an existing machine vision system capturing visual information from a substrate by:
receiving a raw machine vision digital signal from an acquisition device, wherein said raw machine vision digital data signal is in a machine vision acquisition device format;
identifying digital data elements associated with a artifact in said raw machine vision digital data signal, wherein said artifact is not detectable by said machine vision consumption device;
transcoding the raw machine vision digital data signal by rendering the artifact detectable in a transcoded machine vision digital data signal by said machine vision consumption device;
outputting the transcoded machine vision digital signal to a consumption device, wherein said transcoded machine vision digital data signal is in a consumption device format.

40. The non-transitory computer-readable medium of claim 39, wherein said machine vision acquisition device format and the machine vision consumption device format are compatible or are the same format.

41. The non-transitory computer-readable medium of either one of claim 39 or 40, wherein at least one of said machine vision acquisition device format and the machine vision consumption device format comprises an ethernet-based communication protocol.

42. The non-transitory computer-readable medium of claim 41, wherein said ethernet-based communication protocol is: GigE Vision, USB3 Vision, Camera Link, MIPI, or GenICam.

43. The non-transitory computer-readable medium of any one of claims 39 to 42, wherein said rendering comprises at least one of adding, removing, or updating one or more digital data elements comprised relating to said artifact.

44. The non-transitory computer-readable medium of claim 39, wherein the raw machine vision data signal comprises digital image data from one or more images.

45. The non-transitory computer-readable medium of claim 44, wherein the one or more artifacts correspond to features in said one or more images.

46. The non-transitory computer-readable medium of claim 45, wherein the features correspond to at least one of visual features and non-visual features.

47. The non-transitory computer-readable medium of claim 46, wherein said rendering comprises adding digital data to render non-visual features in said raw machine vision digital signal into visual features in said transcoded machine vision digital data signal.

48. The non-transitory computer-readable medium of claim 47, wherein said rendering comprises adding visual elements to said features.

49. The non-transitory computer-readable medium of claim 48, wherein said visual elements comprise text, shapes, colour, texture, or additional images on said one or more images.

50. The non-transitory computer-readable medium of any one of claims 39 to 49, wherein said rendering comprises tagging feature-identifying data with one or more digital data elements.

51. The non-transitory computer-readable medium of claim 39, wherein said rendering comprises combining said raw machine vision digital data signal with a further machine vision digital data signal from a further acquisition device.

52. The non-transitory computer-readable medium of any one of claims 39 to 51, wherein the raw machine vision digital data signal comprises, at least in part, non-image data.

53. The non-transitory computer-readable medium of claim 52, wherein said non-image data comprises sensor output data.

54. The non-transitory computer-readable medium of any one of claims 39 to 53, wherein said digital data processor completes identification of digital data elements and transcoding said transcoded machine vision digital data signal within a latency limit.

55. The non-transitory computer-readable medium of claim 54, wherein said latency limit provides one of real-time machine vision analysis or near real-time machine vision analysis.

56. The non-transitory computer-readable medium of any one of claims 39 to 55, wherein said digital data processor is further configured to send control signals for controlling functionality of said acquisition device.

57. The non-transitory computer-readable method of claim 56, wherein the control signals originate from one or more of: the digital data processor or the consumption device.
